(19) United States
(12) Patent Application Publication
(10) Pub. No.: US 2026/0040194 A1
(43) Pub. Date: Feb. 5, 2026

(54) Automated Frequency Coordination Registration

(71) Applicant: Cisco Technology, Inc., San Jose, CA (US)

(72) Inventors: Jerome Henry, Pittsboro, NC (US); Peiman Amini, Fremont, CA (US); Matthew S. MacPherson, Apex, NC (US); Ardalan Alizadeh, Alizadeh, CA (US)

(21) Appl. No.: 18/795,038

(22) Filed: Aug. 5, 2024

(51) Int. Cl. H04W 48/16

(52) U.S. Cl. CPC H04W 48/16

(57) ABSTRACT

Devices, systems, methods, and processes for location discovery of an access point (AP) are described herein. The AP, after a reboot event, is required to transmit a current location for automated frequency coordination (AFC) registration. However, the current location may be unknown to the AP. To address this, a device is provided with a location discovery logic that determines the current location of the AP. The device may receive first neighborhood discovery data (NDD) of the AP after first boot event and may generate an RF proximity map based on the first NDD. The device may receive the second NDD of the AP based on the reboot event. The device may compare the second NDD with the RF proximity map, and if the second NDD matches the RF proximity map, the device may determine the current location to be same as a reference location associated with the RF proximity map.

The present disclosure relates to wireless networks. More particularly, the present disclosure relates to expedited automated frequency coordination (AFC) registration of network devices.

### BACKGROUND

In the present era, communication among devices is highly dependent on wireless networks that provide connectivity for a vast range of devices. A wireless network may include multiple access points (APs) that facilitate communication among the devices via radio frequency (RF) channels. These devices may include, for example, smartphones, tablets, laptops, desktop computers, smart home appliances, entertainment and media devices, Internet of Things (IoT) devices, or the like which connect to the APs to access the Internet, applications, and services.

For providing network coverage, each AP is allocated a set of RF channels, a power budget, an operation mode, or the like. These allocations are determined based on the number and the type of devices within a communication range of the AP. Notably, to receive the abovementioned allocations, the AP may be required to register with an automated frequency coordination (AFC) server. This registration process typically occurs at regular intervals or after a reboot of the AP. For registering with the AFC server, the AP is required to communicate its current location to the AFC server.

Traditionally, APs have relied on global positioning system (GPS) modules for location determination. However, GPS-based location determination typically requires an unobstructed view of five or more GPS satellites, which is not always feasible. In many cases, the AP may have a limited view of one or two satellites. Under such conditions, determining the AP's location can be delayed. Consequently, at the time of reboot when AP's location is required for AFC registration, such a delay can disrupt network connectivity.

### SUMMARY OF THE DISCLOSURE

Systems and methods for facilitating expedited automated frequency coordination (AFC) registration in accordance with embodiments of the disclosure are described herein. In many embodiments, a device including a processor, a network interface controller configured to provide access to a network, and a memory communicatively coupled to the processor, is provided. The memory may include a location discovery logic that is configured to generate a radio frequency (RF) proximity map associated with a reference location, receive neighborhood discovery data from a network device, and determine that a current location of the network device is same as the reference location based on the RF proximity map and the neighborhood discovery data.

In a number of embodiments, the location discovery logic receives the neighborhood discovery data based on a reboot of the network device.

In a variety of embodiments, the reference location associated with the RF proximity map is a last known location of the network device prior to the reboot.

In more embodiments, the neighborhood discovery data includes at least one of: a received signal strength indicator (RSSI), a service set identifier (SSID), or a basic service set identifier (BSSID), associated with the network device.

In further embodiments, the neighborhood discovery data further includes at least one of: echo data, beacon data, SSID data, BSSID data, or RSSI data, associated with one or more other network devices.

In additional embodiments, the one or more other network devices are positioned within a threshold proximity of the network device.

In yet more embodiments, the network includes a plurality of RF channels.

In still more embodiments, the location discovery logic is further configured to receive the neighborhood discovery data for one or more RF channels of the plurality of RF channels.

In still yet more embodiments, the location discovery logic generates the RF proximity map at a first boot event of the network device.

In many further embodiments, the location discovery logic is further configured to periodically update the RF proximity map.

In many additional embodiments, prior to generating the RF proximity map, the location discovery logic is further configured to receive at least one of: an RSSI, an SSID, or a BSSID, associated with the network device at the first boot event.

In still further embodiments, prior to generating the RF proximity map, the location discovery logic is further configured to receive at least one of: echo data, beacon data, SSID data, BSSID data, or RSSI data, associated with one or more other network devices within a threshold proximity of the network device at the first boot event.

In numerous embodiments, the location discovery logic generates the RF proximity map based on at least one of: the RSSI, the SSID, or the BSSID, associated with the network device at the first boot event and at least one of: the echo data, the beacon data, the SSID data, the BSSID data, or the RSSI data, associated with the one or more other network devices at the first boot event.

In numerous additional embodiments, at least one other network device of the one or more other network devices is coupled with the device.

In several embodiments, the location discovery logic is further configured to determine the current location of the network device based on a physical address of the at least one other network device.

In several more embodiments, the location discovery logic is further configured to transmit the current location of the network device to an Automated Frequency Coordination (AFC) server.

In several additional embodiments, the location discovery logic is further configured to receive AFC configuration data from the AFC server based on the transmission of the current location of the network device and configure the network device based on the AFC configuration data.

In many more embodiments, for determining the current location of the network device, the location discovery logic is further configured to compare the RF proximity map with the neighborhood discovery data and determine an RF neighborhood stability (RNS) score based on the comparison. The determination that the current location of the network device is same as the reference location is based on the RNS score being greater than a threshold probability score.

In various embodiments, a device including a processor, a network interface controller configured to provide access to a network, and a memory communicatively coupled to the processor, is provided. The memory includes a location discovery logic that is configured to transmit, to a network device, first neighborhood discovery data corresponding to a known location of the device, detect a reboot event of the device, transmit, in response to detecting the reboot event, second neighborhood discovery data to the network device while a current location of the device is unknown, and receive Automated Frequency Coordination (AFC) configuration data from the network device based on a match of the second neighborhood discovery data with the first neighborhood discovery data.

In yet various embodiments, a method includes generating a radio frequency (RF) proximity map associated with a reference location, receiving neighborhood discovery data from a network device, and determining that a current location of the network device is same as the reference location based on the RF proximity map and the neighborhood discovery data.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of a wireless local networking system, in accordance with various embodiments of the disclosure;

FIG. 2 is a schematic diagram of an example network architecture for expedited location discovery in accordance with various embodiments of the disclosure;

FIG. 3 is a schematic diagram that illustrates an example scenario for expedited location discovery for automated frequency coordination (AFC) registration in accordance with various embodiments of the disclosure;

FIG. 4 is a flowchart showing a process for location discovery of an access point (AP) in accordance with various embodiments of the disclosure;

FIG. 5 is a flowchart showing a process for location discovery of an AP based on a radio frequency (RF) neighborhood stability score in accordance with various embodiments of the disclosure;

FIG. 6 is a flowchart showing a process for expedited location discovery of an AP at a reboot event in accordance with various embodiments of the disclosure;

FIG. 7 is a flowchart showing a process for AFC registration of an AP at a reboot event in accordance with various embodiments of the disclosure; and

FIG. 8 is a conceptual block diagram of a device suitable for configuration with a location discovery logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are described herein that can facilitate expedited automated frequency coordination (AFC) registration for an access point (AP) that may have rebooted. In the present era, communication among devices is highly dependent on wireless networks that provide connectivity for a vast range of devices. A wireless network may include multiple APs that facilitate communication among the devices via radio frequency (RF) channels. For providing network coverage, each AP is allocated a set of RF channels, a power budget, an operation mode, or the like. In order to receive the abovementioned allocations, the AP may be required to register with an AFC server. For registering with the AFC server and to leverage a standard power mode, the AP is required to communicate its current location to the AFC server.

Generally, an AP may be required to transmit its current location to the AFC server periodically (for example, after every 24 hours) or upon reboot. Notably, the AP may reboot due to multiple reasons such as system updates, system crashes, system restores, or the like. To provide uninterrupted connectivity, it may be required to restore the AP to its full operational capability as quickly as possible.

Traditionally, APs have relied on global positioning system (GPS) modules for location determination. However, GPS-based location determination may require an unobstructed view of multiple satellites (for example, 5 or more satellites), which is not always feasible. In many instances, the AP may not have the unobstructed view of a required number of satellites. Under such conditions, determining the AP's location can be delayed (for example, 12 minutes to 24 hours), which in turn delays AFC registration. Such delays in AFC registration are undesirable, especially in case of a rebooting AP as it leads to significant downtime of the AP.

In many embodiments, an AP may be positioned within a wireless network. The AP may be associated with a network device (for example, a wireless network controller). Upon a first boot event of the AP, first neighborhood discovery data (NDD) may be transmitted by the AP to the network device. The first NDD may refer to information that the AP collects about nearby network devices within its discovery range. The first NDD may include a received signal strength indicator (RSSI), a service set identifier (SSID), or a basic service set identifier (BSSID), associated with the AP at the first boot event. The first NDD may further include echo data, beacon data, RSSI data, SSID data, or BSSID data, associated with one or more nearby network devices positioned within a threshold proximity of the AP.

In several embodiments, the network device may be configured to generate a radio frequency (RF) proximity map based on the first NDD. The RF proximity map may be associated with a reference location. The reference location may be a known location of the AP at the first boot event.

In several additional embodiments, the AP may undergo a reboot event. In response to the reboot event, the AP may be required to perform AFC registration with the AFC server. Therefore, the AP may transmit second NDD to the network device. The second NDD may include an RSSI, an SSID, or a BSSID, of the AP at the reboot event. The second NDD may further include echo data, beacon data, SSID data, BSSID data, or RSSI data, associated with other nearby network devices present within the threshold proximity of the AP at the reboot event.

In a variety of embodiments, the network device may compare the second NDD with the RF proximity map for the AP. Based on the comparison, the network device may determine whether the second NDD matches the RF proximity map. In other words, the network device may determine whether a current RF proximity map of the AP at the reboot event matches the stored RF proximity map. Based on a match of the second NDD with the RF proximity map, the network device may determine the reference location associated with the RF proximity map to be a current location of the AP. In other words, if the current RF proximity map of the AP at the reboot event matches the stored RF proximity map, the network device may establish that the AP is still at the same reference location for which the stored RF proximity map was generated.

In further embodiments, the network device may be configured to communicate the determined current location of the AP to the AFC server. The AFC server may generate AFC configuration data including power levels, operation mode, or the like for the AP. The AFC server may transmit the AFC configuration data to the network device and the network device may transmit the AFC configuration data to the AP. Consequently, the AP may initiate its operation in accordance with the AFC configuration data.

In more embodiments, the network device may be configured to determine an RF neighborhood stability (RNS) score for the AP. The RNS score may be determined based on the comparison of the second NDD with the RF proximity map. The network device may determine that the reference location associated with the RF proximity map may be the current location of the AP based on the RNS score being greater than a threshold probability score.

In yet more embodiments, at least one network device of the other network devices within the threshold proximity of the AP may be coupled with the network device. Therefore, the network device may be aware of a physical address of the at least one network device. In such embodiments, the network device may be configured to determine and validate the current location of the AP based on the physical address of the at least one network device. In other words, the network device may determine and validate the current location of the AP by determining a location of the at least one network device based on its physical address.

Thus, a network device (e.g., a wireless network controller or an AFC server) that can determine a current location of an AP that has just rebooted is provided. The determination of the current location of the AP is performed based on a previously generated RF proximity map and NDD of the AP at a reboot event. The RF proximity map may be associated with a reference location of the AP. The reference location may be the last known location of the AP before the reboot event. For example, the reference location may correspond to a location of the AP determined at a first boot event. When the NDD associated with the AP at the reboot time matches the RF proximity map, the network device may determine that the current location of the AP is the same as the reference location. Since the current location is determined by matching RF data associated with the AP and network devices within a threshold proximity of the AP at the first boot event and the reboot event, the current location gets validated in a shorter time. Further, such determination of the current location of the AP allows the AP to restore its full operation faster as compared to obtaining the current location from GPS modules at reboot events. Thus, the AP may provide network connectivity without interruption or significant delay.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like), or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer-readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in still yet more embodiments, may alternatively be embodied by or implemented as a component.

A circuit, as used herein, comprises a set of one or more electrical and/or electronic components providing one or more pathways for electrical current. In many additional embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to the ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as a field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

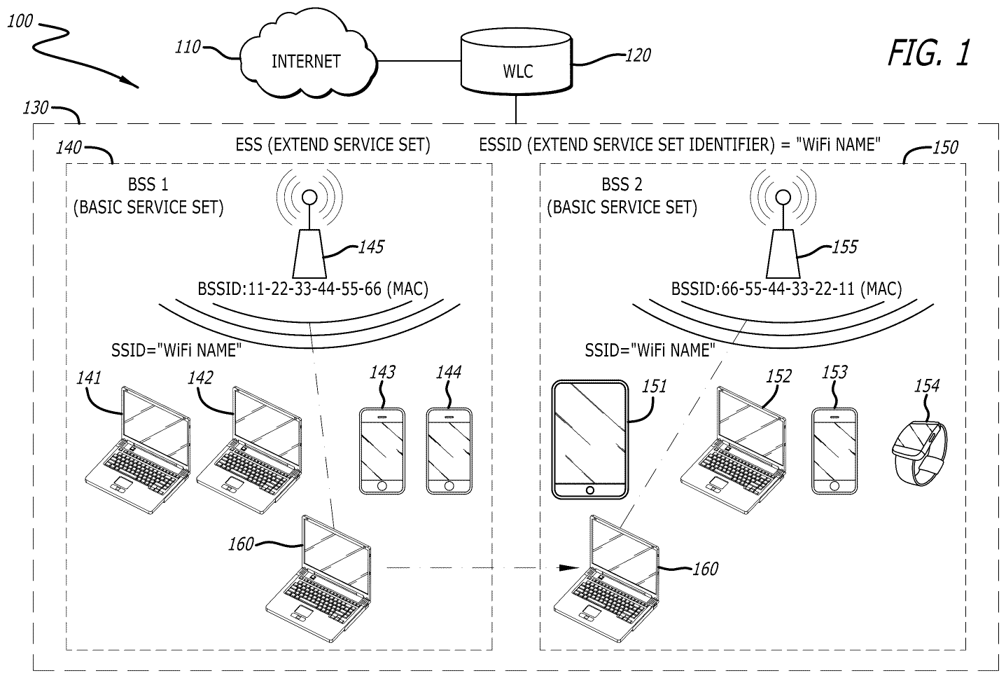

Referring to FIG. 1, a schematic block diagram of a wireless local networking system 100, in accordance with various embodiments of the disclosure is shown. Wireless local networking standards play a crucial role in enabling seamless communication and connectivity between various devices within localized areas. One of the most prevalent standards is Wi-Fi, which is based on the IEEE 802.11 family of protocols. Wi-Fi provides high-speed wireless access to the internet and local network resources, with iterations such as 802.11a, 802.11b, 802.11g, 802.11n, 802.11ac, and 802.11ax, each offering improvements in speed, range, and efficiency. Each adoption of Wi-Fi standards is often designed to bring enhanced performance, increased capacity, and better efficiency in crowded network environments. Other standards can commonly be used for short-range wireless communication between devices, particularly in the realm of personal area networks (PANs). Both Wi-Fi and other protocols have become integral components of modern connectivity, supporting a wide range of devices and applications across homes, businesses, and public spaces. Emerging technologies and future iterations continue to refine wireless networking standards, ensuring the evolution of efficient, reliable, and secure wireless communication.

In the realm of IEEE 802.11 wireless local area networking standards, commonly associated with Wi-Fi technology, a service set plays a pivotal role in defining and organizing wireless network devices. A service set essentially refers to a collection of wireless devices that share a common service set identifier (SSID). The SSID, often recognizable to users as the network name presented in natural language, serves as a means of identification and differentiation among various wireless networks. Within a service set, the nodes comprising devices like laptops, smartphones, or other Wi-Fi-enabled devices operate collaboratively, adhering to shared link-layer networking parameters. These parameters encompass specific communication settings and protocols that facilitate seamless interaction among the devices within the service set. Essentially, a service set forms a cohesive and logical network segment, creating an organized structure for wireless communication where devices can communicate and share data within the defined parameters, enhancing the efficiency and coordination of wireless networking operations.

In the context of wireless local area networking standards, a service can be configured in two distinct forms: a basic service set (BSS) or an extended service set (ESS). A basic service set represents a subset within a service set, comprised of devices that share common physical-layer medium access characteristics. These characteristics include parameters such as radio frequency, modulation scheme, and security settings, ensuring seamless wireless networking among the devices. The basic service set is uniquely identified by a basic service set identifier (BSSID), a 48-bit label adhering to MAC-48 conventions. Despite the possibility of a device having multiple BSSIDs, each BSSID is typically associated with, at most, one basic service set at any given time.

It is important to note that a basic service set should not be confused with the coverage area of an access point, which is referred to as the basic service area (BSA). The BSA encompasses the physical space within which an access point provides wireless coverage, while the basic service set focuses on the logical grouping of devices sharing common networking characteristics. This distinction emphasizes that the basic service set is a conceptual grouping based on shared communication parameters, while the basic service area defines the spatial extent of an access point's wireless reach. Understanding these distinctions is fundamental for effectively configuring and managing wireless networks, ensuring optimal performance and coordination among connected devices.

The service set identifier (SSID) defines a service set or extends a service set. Normally it is broadcast in the clear by stations in beacon packets to announce the presence of a network and seen by users as a wireless network name. Unlike basic service set identifiers, SSIDs are usually customizable. Since the contents of an SSID field are arbitrary, the 802.11 standard permits devices to advertise the presence of a wireless network with beacon packets. A station may also likewise transmit packets in which the SSID field is set to null; this prompts an associated access point to send the station a list of supported SSIDs. Once a device has associated with a basic service set, for efficiency, the SSID is not sent within packet headers; only BSSIDs are used for addressing.

An extended service set (ESS) is a more sophisticated wireless network architecture designed to provide seamless coverage across a larger area, typically spanning environments such as homes or offices that may be too expansive for reliable coverage by a single access point. This network is created through the collaboration of multiple access points, presenting itself to users as a unified and continuous network experience. The extended service set operates by integrating one or more infrastructure basic service sets (BSS) within a common logical network segment, characterized by sharing the same IP subnet and VLAN (Virtual Local Area Network).

The concept of an extended service set is particularly advantageous in scenarios where a single access point cannot adequately cover the entire desired area. By employing multiple access points strategically, users can move seamlessly across the extended service set without experiencing disruptions in connectivity. This is crucial for maintaining a consistent wireless experience in larger spaces, where users may transition between different physical locations covered by distinct access points.

Moreover, extended service sets offer additional functionalities, such as distribution services and centralized authentication. The distribution services facilitate the efficient distribution of network resources and services across the entire extended service set. Centralized authentication enhances security and simplifies access control by allowing users to authenticate once for access to any part of the extended service set, streamlining the user experience and network management. Overall, extended service sets provide a scalable and robust solution for ensuring reliable and comprehensive wireless connectivity in diverse and expansive environments.

The network can include a variety of user end devices that connect to the network. These devices can sometimes be referred to as stations (i.e., “STAs”). Each device is typically configured with a medium access control (“MAC”) address in accordance with the IEEE 802.11 standard. A physical layer can also be configured to communicate over the wireless medium. Various devices on a network can include components such as a processor, transceiver, user interface, etc. These components can be configured to process frames of data transmitted and/or received over the wireless network. Access points (“APs”) are wireless devices configured to provide access to user end devices to a larger network, such as the Internet 110.

In the embodiment depicted in FIG. 1, a wireless network controller 120 (shown as WLC) is connected to a public network such as the Internet 110. The wireless network controller 120 is in communication with an extended service set (ESS 130). The ESS 130 comprises two separate basic service sets (BSS 1 140 and BBS 2 150). The ESS 130, BSS 1 140, and BSS 2 150 all broadcast and are configured with the same SSID “WiFi Name”, which can be a BSSID for each of the BSS 1 140 and BSS 2 150 as well as an ESSID for the ESS 130.

Within the first BSS 1 140, the network comprises a first notebook 141 (shown as “notebook1”), a second notebook 142 (shown as “notebook2”), a first phone 143 (shown as “phone1”) and a second phone 144 (shown as “phone2”), and a third notebook 160 (shown as “notebook3”). Each of these devices can communicate with the first access point 145. Likewise, in the second BSS 2 150, the network comprises a first tablet 151 (shown as “tablet1”), a fourth notebook 152 (shown as “notebook4”), a third phone 153 (shown as “phone3”), and a first watch 154 (shown as “watch1”). The third notebook 160 is communicatively collected to both the first BSS 1 140 and the second BSS 2 150. In this setup, third notebook 160 can be seen to “roam” from the physical area serviced by the first BSS 1 140 and into the physical area serviced by the second BSS 2 150.

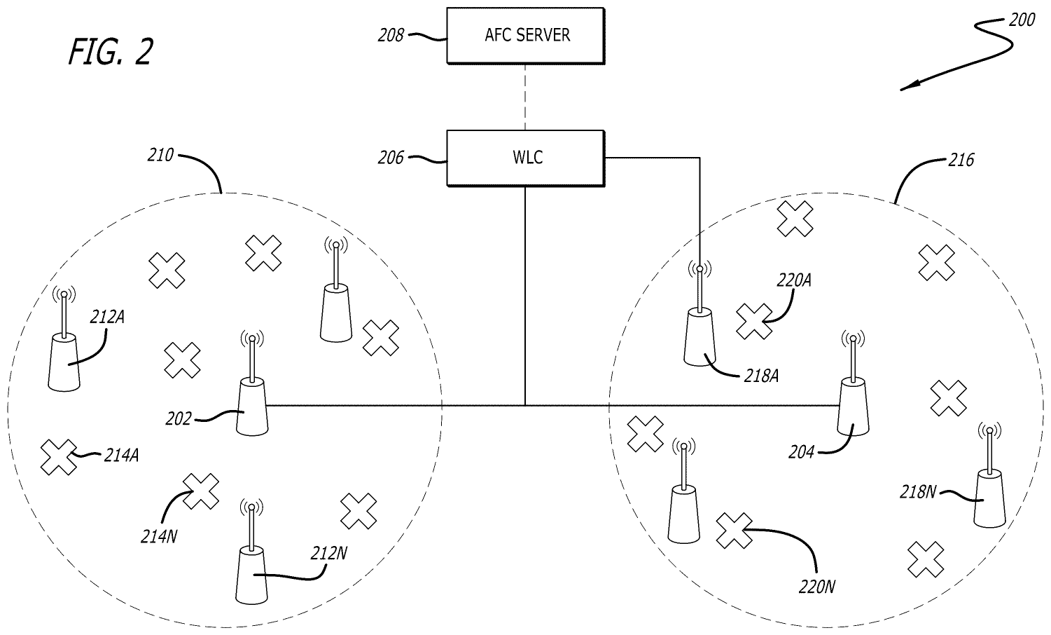

Although a specific embodiment for the wireless local networking system 100 is described above with respect to FIG. 1, any of a variety of systems and/or processes may be utilized in accordance with embodiments of the disclosure. For example, the wireless local networking system 100 may be configured into any number of various network topologies including different types of interconnected devices and user devices. The elements depicted in FIG. 1 may also be interchangeable with other elements of FIGS. 2-8 as required to realize a particularly desired embodiment.

Referring to FIG. 2, a schematic diagram of an example network architecture 200 for expedited location discovery in accordance with various embodiments of the disclosure is shown. The embodiments shown in FIG. 2 may illustrate a scenario where the network architecture 200 includes a first AP 202, a second AP 204, a wireless Local Area Network (LAN) controller 206 (shown as WLC 206), and an Automated Frequency Coordination (AFC) server 208. The first and second APs 202 and 204 may be associated with the WLC 206. The WLC 206 may be associated with the AFC server 208. In an example, the first and second APs 202 and 204 may use a 6 gigahertz (GHz) band in addition to 2.4 GHz band and 5 GHz band.

In many embodiments, the first AP 202 may be a network node that includes a processor and a network interface controller configured to provide access to a network (for example, a wireless network). The first AP 202 may have a coverage within which it allows Wi-Fi devices such as laptops, smartphones, tablets, or the like to connect to the network. The first AP 202 may further include a memory that may be coupled with the processor and may store a location discovery logic executable by the processor. In more embodiments, the first AP 202 may execute the location discovery logic to perform one or more operations related to location discovery. The first AP 202 may have a range (e.g., a threshold proximity 210) within which the first AP 202 may perform device discovery. Such a range may be referred to as a neighborhood of the first AP 202. The neighborhood of the first AP 202 may include various network devices such as one or more other APs, one or more base stations, one or more RF devices, one or more non-RF devices, or the like. In other words, the first AP 202 may have various Wi-Fi devices or non-Wi-Fi devices positioned within the threshold proximity 210 of the first AP 202. Here, the threshold proximity 210 may correspond to the neighborhood of the first AP 202 within which the first AP 202 can perform device discovery. As shown, a plurality of APs 212A-N and a plurality of network devices 214A-N are positioned within the threshold proximity 210. The plurality of network devices 214A-N may include base stations, RF devices, or the like. Although not shown, a plurality of non-Wi-Fi devices, static objects, and dynamic objects can also be positioned within the threshold proximity 210 and may cause RF interference within the threshold proximity 210.

Likewise, the second AP 204 may be another network node that includes a processor and a network interface controller configured to provide access to the network (for example, a wireless network). The second AP 204 may have a coverage within which it allows Wi-Fi devices such as laptops, smartphones, tablets, or the like to connect to the network. The second AP 204 may further include a memory that may be coupled with the processor and may store the location discovery logic executable by the processor. In numerous additional embodiments, the second AP 204 may execute the location discovery logic to perform one or more operations related to location discovery. The second AP 204 may have a range (e.g., a threshold proximity 216) within which the second AP 204 may perform device discovery. Such a range may be referred to as a neighborhood of the second AP 204. The neighborhood (e.g., the threshold proximity 216) of the second AP 204 may include various network devices such as one or more other APs, one or more base stations, one or more RF devices, one or more non-RF devices, or the like. As shown in FIG. 2, a plurality of APs 218A-N and a plurality of network devices 220A-N are positioned within the threshold proximity 216. The plurality of network devices 220A-N may include base stations, RF devices, or the like. Although not shown, a plurality of non-Wi-Fi devices, static objects, and dynamic objects can also be positioned within the threshold proximity 216 and may cause RF interference within the threshold proximity 216.

In yet more embodiments, the WLC 206 may be a network node that may include a processor and a network interface controller configured to provide access to the network (for example, a wireless network). In many examples, the WLC 206 may be a physical device. In many additional examples, the WLC 206 may be a logical device. The WLC 206 may further include a memory that may be coupled with the processor and may store the location discovery logic. The WLC 206 may be configured to manage multiple APs within the network. For example, the WLC 206 may centralize the control and configuration, task handling such as security enforcement, RF management, and firmware updates, or the like for the first and second APs 202 and 204, a third AP 218A, etc. The WLC 206 may be further configured to execute the location discovery logic to perform one or more operations for location discovery of associated APs (for example, the first and second APs 202 and 204 and the third AP 218A) within the network. Further, the WLC 206 may be configured to coordinate frequency usage among APs to ensure compliance with regulatory mandates and optimize network performance.

As mentioned previously, the WLC 206 may be associated with the AFC server 208 for coordinating frequency usage among the first and second APs 202 and 204, and the third AP 218A. In many examples, the WLC 206 may negotiate with the AFC server 208 on behalf of the associated APs (e.g., the first and second APs 202 and 204 and the third AP 218A) for frequency usage. In many additional examples, the WLC 206 may transmit a current location of an AP to the AFC server 208, and based on the transmitted current location, the WLC 206 may receive AFC configuration data from the AFC server 208. The WLC 206 may then transmit the AFC configuration data to the AP to configure the AP. Subsequently, the AP may operate in accordance with the AFC configuration data.

In further embodiments, the AFC server 208 may be another network node configured to determine and provide lists of frequencies that are available for use by 802.11-based network devices. In various embodiments, the AFC server 208 may be configured to maintain access to a central or distributed database of spectrum availability. For example, the database may include information regarding which frequency channels can be used in specific geographic locations. Further, the database may maintain a record of all licensed users in these geographic locations, including information on transmitters and receivers of incumbent users that have priority access to certain frequencies. The AFC server 208 may be further configured to monitor the spectrum environment to provide real-time data to the WLC 206, enabling the WLC 206 to manage channel assignments for the associated APs.

Though in FIG. 2, the AFC server 208 is shown to connect to various APs (e.g., the first and second APs 202 and 204 and the third AP 218A) via the WLC 206, the scope of the disclosure is not limited to it. In yet further embodiments, the AFC server 208 may directly connect to APs, for example, through the Internet, to allocate frequency resources.

In many additional embodiments, the AFC server 208 may be configured to receive the current location of the associated APs periodically (for example, after every 24 hours) or at each reboot of the AP, and generate AFC configuration data for the associated APs based on the received current location. The AFC configuration data may be indicative of power level, operation mode, or the like for each associated AP. As mentioned above, the AFC server 208 may transmit the AFC configuration data to the WLC 206, which in turn provides the AFC configuration data to the associated APs.

Traditionally, APs include a global positioning system (GPS) module using which the APs determine their location and provide the determined location, via a WLC or directly, to an AFC server for frequency coordination. However, in many instances, the AP may not have an unobstructed view of a required number of satellites, and therefore, may take a prolonged time-interval (for example, 12 minutes to 24 hours) to determine the current location, which in turn can delay AFC registration of the AP with the AFC server. Such an approach may be impractical as it can lead to significant downtime of the AP at each reboot event and disruption in network coverage, which is undesirable.

As a solution to the abovementioned issues, the present disclosure describes systems and methods to accelerate location discovery for a rebooting AP and in turn, expedite the time for AFC registration. In various embodiments, at a first boot event of the first AP 202, the first AP 202 may transmit first neighborhood discovery data (hereinafter, denoted as “NDD”) to the WLC 206. The first NDD may be indicative of RF information associated with the first AP 202 and RF devices and non-RF devices within the neighborhood (e.g., the threshold proximity 210) of the first AP 202. The first NDD may include a received signal strength indicator (RSSI) of the first AP 202, an SSID of the first AP 202, and a BSSID of the first AP 202 at the first boot event. The first NDD may further include echo data, beacon data, SSID data, BSSID data, and RSSI data associated with the plurality of APs 212A-N and the plurality of network devices 214A-N. The echo data may be further indicative of static objects within the threshold proximity 210 at the first boot event of the first AP 202. The first NDD may be used to determine an RF environment of the first AP 202 at the first boot event.

In a number of embodiments, the WLC 206 may be configured to receive the first NDD from the first AP 202. The WLC 206 may be further configured to determine the RF environment of the first AP 202 based on the first NDD. For determining the RF environment of the first AP 202, the WLC 206 may generate an RF proximity map for the first AP 202 based on the first NDD. The RF proximity map may be indicative of the positions of each of the plurality of APs 212A-N, the plurality of network devices 214A-N, other non-Wi-Fi devices, static objects, or the like within the threshold proximity 210 (e.g., the neighborhood of the first AP 202) of the first AP 202. Additionally, the WLC 206 may further receive a reference location from the first AP 202. The reference location may be a known location of the first AP 202 after the first boot event. The WLC 206 may associate the reference location with the RF proximity map. Such association may indicate that the first AP 202 may be associated with an RF environment presented by the RF proximity map when the first AP 202 is located at the reference location. The WLC 206 may be configured to store the RF proximity map and the associated reference location in corresponding memory.

In a variety of embodiments, the WLC 206 may be further configured to update the RF proximity map periodically. Such an update of the RF proximity map may be performed based on a new NDD received by the WLC 206 from the first AP 202. The new NDD may be transmitted by the first AP 202 periodically or based on a change of location of the first AP 202. Additionally, the new NDD may be transmitted by the first AP 202 based on a change of position of any of the plurality of APs 212A-N, the plurality of network devices 214A-N, other non-Wi-Fi devices, static objects, or the like within the threshold proximity 210. In addition to providing the new NDD, the first AP 202 may provide a new reference location of the first AP 202. Thus, enabling the WLC 206 to update the reference location as well while updating the RF proximity map of the first AP 202.

In further additional embodiments, the WLC 206 may be configured to acquire the new NDD periodically. For example, the WLC 206 may be configured to communicate a nudge signal to the first AP 202 periodically, and based on reception of the nudge signal, the first AP 202 may communicate the new NDD to the WLC 206.

In still yet more embodiments, the first AP 202 may undergo a reboot event. After the reboot event, the first AP 202 may initiate its operation in low power indoor (LPI) mode. Based on the reboot event, the first AP 202 may be required to perform AFC registration again to leverage the standard power mode. Notably, for performing the AFC registration, the first AP 202 may require communicating its current location to the AFC server 208. However, the first AP 202 may be unaware of its current location and determination of the current location may be a time-intensive process, which may compromise a quality of service of the first AP 202. Therefore, the first AP 202 may transmit second NDD to the WLC 206 for performing location discovery for the first AP 202. The second NDD may include an SSID, a BSSID, and an RSSI associated with the first AP 202 at the reboot event. The second NDD may further include echo data, beacon data, RSSI data, SSID data, and BSSID data, associated with the one or more devices within the threshold proximity 210 of the first AP 202 at the reboot event.

In additional embodiments, the WLC 206 may receive the second NDD from the first AP 202 and compare the RF proximity map with the second NDD. Based on the match of the second NDD with the RF proximity map, the WLC 206 may determine the reference location associated with the RF proximity map to be a current location of the first AP 202. In other words, if a current RF proximity map (indicated by the second NDD) at the reboot event matches the stored RF proximity map, the WLC 206 may establish that the first AP 202 is still at the same reference location for which the stored RF proximity map was generated.

In many further embodiments, the WLC 206 may be configured to communicate the current location of the first AP 202 to the AFC server 208. The AFC server 208, based on the reception of the current location of the first AP 202, may generate AFC configuration data for the first AP 202. The AFC configuration data may include power levels, mode of operation, or the like according to which the first AP 202 is required to operate. The AFC server 208 may communicate the AFC configuration data to the WLC 206. The WLC 206 may transmit the AFC configuration data to the first AP 202 which may initiate its operation by implementing the AFC configuration data.

Similarly, the WLC 206 may be further configured to create another RF proximity map for the second AP 204 at a first boot event of the second AP 204. Based on a reboot event of the second AP 204, the second AP 204 may be configured to transmit corresponding second NDD to the WLC 206. However, the WLC 206 may determine that the second NDD may not match the RF proximity map for the second AP 204. Notably, the plurality of APs 218A-N may include the third AP 218A that may be coupled with the WLC 206. The third AP 218A may be controlled by the WLC 206. The WLC 206 may apply specific flags to APs within the network that may be controlled by the WLC 206. The WLC 206 may record the element identity (for example, a physical address) of such APs. The WLC 206 may further record other parameters of importance (for example, AFC configuration, power level, operation mode, or the like) associated with such APs.

In still more embodiments, the WLC 206 may determine a current location of the second AP 204 based on the physical address of the third AP 218A. The physical address (namely, Media Access Control “MAC” address) of the third AP 218A may be utilized by the WLC 206 to determine the physical location of the third AP 218A. The WLC 206 may determine the physical location of the third AP 218A as the current location of the second AP 204.

In still further embodiments, the WLC 206 may have an RF proximity map of the third AP 218A. Based on the second NDD of the second AP 204 not being a match to the RF proximity map of the second AP 204, the WLC 206 may match the second NDD of the second AP 204 with the RF proximity map of the third AP 218A. The second NDD of the second AP 204 may match the RF proximity map of the third AP 218A. Therefore, the location discovery logic may determine a reference location associated with the RF proximity map of the third AP 218A as a current location of the second AP 204.

In numerous additional embodiments, the WLC 206 may be associated with a plurality of BSSs whose BSSIDs may be included in the first and second NDD of the second AP 204. In such embodiments, the WLC 206 may compare Wi-Fi devices reported by the second AP 204 to a known target AP configuration. Such validation may allow the WLC 206 to reconcile previously detected parameters (for example, information elements, SSIDs, or the like) with the second NDD associated with the second AP 204.

In still additional embodiments, the WLC 206 may be configured to communicate the current location of the second AP 204 to the AFC server 208. The AFC server 208, based on the reception of the current location of the second AP 204, may generate AFC configuration data for the second AP 204. The AFC configuration data may include power levels, mode of operation, or the like according to which the second AP 204 is required to operate. The AFC server 208 may communicate the AFC configuration data to the WLC 206. The WLC 206 may transmit the AFC configuration data to the second AP 204 which may initiate its operation by implementing the AFC configuration data.

In numerous embodiments, the first AP 202 may be configured to determine the first NDD, the new NDD, and the second NDD by performing passive scans, communicating network discovery messages, or any other approach that may be known in the art for performing device discovery. In many examples, the first AP 202 can utilize Neighbor Discovery Protocol (NDP) messaging to determine the first NDD, the new NDD, and the second NDD.

Although a specific embodiment for an example network architecture with expedited location discovery for AFC registration suitable for carrying out the various steps, processes, methods, and operations described herein is discussed with respect to FIG. 2, any of a variety of systems and/or processes may be utilized in accordance with embodiments of the disclosure. For example, an AP may be directly coupled with the AFC server 208. In other words, the AP may not be coupled to the AFC server 208 via the WLC 206. In such a scenario, operations performed by the WLC 206 may be performed by the AFC server 208 to determine the current location of the AP for AFC registration. The elements depicted in FIG. 2 may also be interchangeable with other elements of FIGS. 1 and 3-8 as required to realize a particularly desired embodiment.

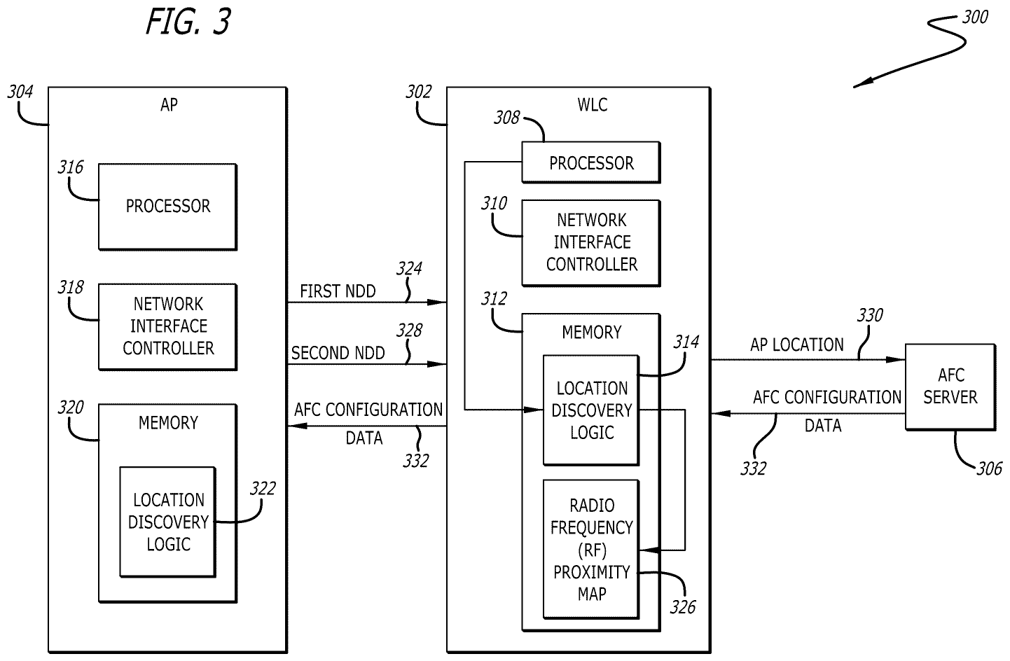

Referring to FIG. 3, a schematic diagram that illustrates an example scenario 300 for expedited location discovery for AFC registration in accordance with various embodiments of the disclosure is shown. The embodiments shown in FIG. 3 illustrates a WLC 302 coupled to an AP 304 and an AFC server 306. The WLC 302 may be a network node in a network (for example, a wireless network). The WLC 302 may include a processor 308, a network interface controller 310 that connects the WLC 302 to a network (for example, a wireless network), and a memory 312 that is accessible to the processor 308. The memory 312 may store a location discovery logic 314 that when executed by the processor 308 may perform one or more operations for determining a current location of the AP 304.

The AP 304 may be another network node in the network (for example, a wireless network). The AP 304 may include a processor 316, a network interface controller 318 that connects the AP 304 to the network, and a memory 320 that stores a location discovery logic 322. The location discovery logic 322 may be accessible and executable by the processor 316.

The AFC server 306 may be yet another network node in the network. The AFC server 306 may generate AFC configuration data for the AP 304 based on a current location of the AP 304. The AF configuration data can be generated in a manner that it meets the operational requirements of the AP 304 while providing connectivity to a corresponding portion of the network.

In many embodiments, the AP 304 may execute a first boot event. The location discovery logic 322 may detect the first boot event. Based on the first boot event of the AP 304, the location discovery logic 322 may transmit a first NDD 324 associated with the AP 304, at the time of the first boot event, to the WLC 302. The first NDD 324 may include an SSID, an RSSI, and a BSSID associated with the AP 304 at the first boot event. The first NDD 324 may further include echo data, beacon data, SSID data, RSSI data, and BSSID data associated with one or more network devices within a threshold proximity of the AP 304. The threshold proximity of the AP 304 may be a radius within which the AP 304 may be able to perform device discovery by detecting Wi-Fi devices and non-WiFi devices. The first NDD 324 may further include information associated with non-WiFi recognized elements (e.g., Bluetooth Low Energy beacons), static objects, and dynamic objects within the threshold proximity of the AP 304. In various embodiments, the AP 304 may generate the first NDD 324 by performing passive scans and/or active scans across a plurality of RF channels associated with the network.

In a number of embodiments, the echo data may include data associated with signals received by the AP 304 that may have been reflected by the one or more network devices within the threshold proximity. The beacon data may include data associated with information broadcasted by the one or more network devices in the form of beacon frames. The beacon data may be utilized to determine network identification of the network devices, capabilities of the network devices, timestamp of reception of the beacon data, channel information associated with the network devices, and signal strength and quality associated with the network devices. The beacon data may further include advertised capabilities and vendor-specific information elements associated with the network devices. The SSID data may include service set identifiers of the network devices and the BSSID data may include basic service set identifiers of the network devices. The RSSI data may include signal strengths associated with the network devices. In addition, the location discovery logic 322 may be further configured to transmit a reference location to the WLC 302. The reference location may be associated with the first NDD 324. Further, the reference location may be the last known location of the AP 304 after the first boot event.

In a variety of embodiments, the first NDD 324 may be received by the WLC 302. The location discovery logic 314 may be configured to generate an RF proximity map 326 based on the first NDD 324. In other words, the first NDD 324 may be received prior to the generation of the RF proximity map 326. The RF proximity map 326 may be generated based on the RF information of the network devices in the threshold proximity of the AP 304. Such RF information of the network devices may be indicated by the first NDD 324. Further, the location discovery logic 314 may be configured to receive the reference location from the AP 304. The location discovery logic 314 may associate the reference location with the RF proximity map 326. Associating the reference location with the RF proximity map 326 may indicate that the RF proximity map 326 pertains to an RF neighborhood of the reference location.

In numerous embodiments, the static objects (for example, walls, furniture, or the like) within the threshold proximity may create specific patterns. The location discovery logic 314 may be configured to compare echoes associated with the static objects over time and may suppress temporal changes and retain elements caused by the static objects.

In further additional embodiments, the AP 304 may execute a reboot event. The location discovery logic 322 may be configured to detect the reboot event. Based on the detection of the reboot event, the location discovery logic 322 may be configured to transmit a second NDD 328 to the WLC 302. The second NDD 328 may include an RSSI, a BSSID, and an SSID, associated with the AP 304 at the time of the reboot event. The second NDD 328 may further include echo data, beacon data, RSSI data, BSSID data, and SSID data, associated with the network devices within the threshold proximity of the AP 304. In many examples, the AP 304 may utilize NDP to determine the second NDD 328.

In more embodiments, the WLC 302 may receive the second NDD 328 from the AP 304. The location discovery logic 314 may be configured to compare the second NDD 328 with the RF proximity map 326. In additional embodiments, for comparing the second NDD 328 with the RF proximity map 326, the location discovery logic 314 may be configured to create a new RF proximity map based on the second NDD 328. In case, the new RF proximity map matches the RF proximity map 326, the location discovery logic 314 may determine the reference location associated with the RF proximity map 326 as an AP location 330 (namely, a current location) of the AP 304. In further embodiments, for comparing the second NDD 328 with the RF proximity map 326, the location discovery logic 314 may be configured to compare the second NDD 328 with the first NDD 324. In case, the second NDD 328 matches the first NDD 324, the location discovery logic 314 may determine the reference location associated with the first NDD 324 as the AP location 330 of the AP 304.

In still more embodiments, for comparing the first NDD 324 and the second NDD 328, the location discovery logic 314 may be configured to apply one or more data matching algorithms known in the art.

In numerous additional embodiments, the location discovery logic 314 may be configured to receive the first NDD 324 periodically. In such embodiments, the location discovery logic 314 may, over a time interval, determine a range (min, mean, max), that can be baselined, for each RSSI in the RSSI data of the network devices within the threshold proximity of the AP 304. The RSSI data in the second NDD 328 may be assumed to be a match in case it lies between the range of the RSSI determined by the location discovery logic 314.

In still further embodiments, the location discovery logic 314 may be configured to transmit the AP location 330 to the AFC server 306. The AFC server 306, based on reception of the AP location 330 of the AP 304, may generate AFC configuration data 332 for the AP 304. The AFC configuration data 332 may include power levels, mode of operation, or the like according to which the AP 304 is required to operate. The AFC server 306 may communicate the AFC configuration data 332 to the WLC 302. The WLC 302 may transmit the AFC configuration data 332 to the AP 304 which may initiate its operation by implementing the AFC configuration data 332.

In several embodiments, examples of the processors 308, 316 may include Application-Specific Integrated Circuit (ASIC) processor, a Reduced Instruction Set Computing (RISC) processor, a Complex Instruction Set Computing (CISC) processor, a Field-Programmable Gate Array (FPGA), a Digital Signal Processor (DSP), or the like. In yet further embodiments, examples of the memories 312, 320 may include random-access memory (“RAM”), read-only memory (“ROM”) non-volatile RAM (“NVRAM”), or the like. In still yet further embodiments, examples of the network interface controllers 310, 318 may include a gigabit Ethernet adapter or other similar components.

Although a specific embodiment for expedited location discovery for AFC registration suitable for carrying out the various steps, processes, methods, and operations described herein is discussed with respect to FIG. 3, any of a variety of systems and/or processes may be utilized in accordance with embodiments of the disclosure. For example, the new RF proximity map and the RF proximity map 326 may be considered to be a match in case the new RF proximity map matches the RF proximity map 326 with a percentage that is greater than a first threshold percentage (for example, “80 percent”). Alternatively, the second NDD 328 and the first NDD 324 may be considered to be a match in case the second NDD 328 matches the first NDD 324 with a percentage that is greater than a second threshold percentage (for example, “90 percent”). The elements depicted in FIG. 3 may also be interchangeable with other elements of FIGS. 1, 2, and 4-8 as required to realize a particularly desired embodiment.

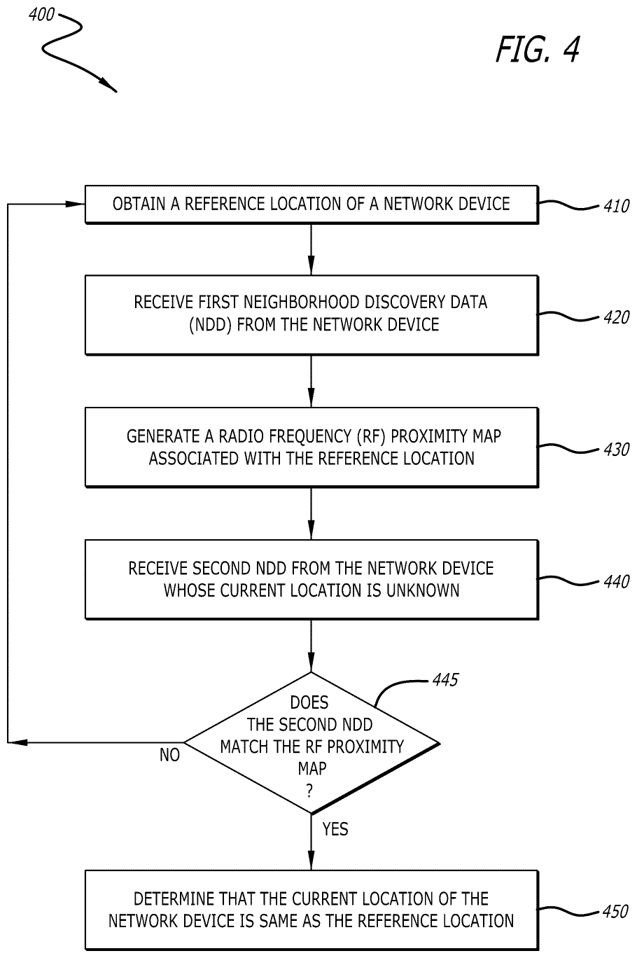

Referring to FIG. 4, a flowchart showing a process 400 for location discovery of an AP in accordance with various embodiments of the disclosure is shown. In many embodiments, the process 400 may obtain a reference location of a network device (block 410). In an example, the network device can be an AP. The process 400 may obtain the reference location of the AP based on a first boot event of the AP. The reference location of the AP may be the last known location of the AP after the first boot event of the AP. In many examples, the reference location can be determined by the AP by utilizing a GPS module or any other ranging technique known in the art.

In a number of embodiments, the process 400 may receive a first NDD from the network device (block 420). The process 400 may receive the first NDD from the AP based on the first boot event of the AP. The first NDD may include an RSSI of the AP, an SSID of the AP, and a BSSID of the AP, for example, at the first event. The first NDD may further include echo data, beacon data, SSID data, BSSID data, and RSSI data associated with network devices located within a threshold proximity of the AP at the first boot event. In a variety of embodiments, the echo data may include signals received by the AP that have been reflected by the network devices within the threshold proximity of the AP. The beacon data may include information broadcasted by the network devices in the form of beacon frames. The beacon data may be used to identify the network devices, assess the capabilities of the network devices, record reception timestamps of the beacon frames, provide channel information associated with the network devices, and evaluate the signal strength and quality associated with the network devices. The SSID data may include service set identifiers of the network devices and the BSSID data may include basic service set identifiers of the network devices. The RSSI data may include signal strengths associated with the network devices.

In further additional embodiments, the process 400 may generate an RF proximity map associated with the reference location (block 430). The process 400 may generate the RF proximity map based on the first NDD. The RF proximity map may be generated based on RF information of the network devices within the threshold proximity of the AP at the first boot event. In other words, the RF proximity map of the AP may be generated based on collected signal snapshots (e.g., the first NDD) of various nearby (e.g., within the threshold proximity) wi-fi devices or non-wi-fi devices of the AP. Further, the RF proximity map can be utilized to decipher the relative location between the AP and the nearby devices and entities. The process 400 may associate the reference location with the RF proximity map.

In more embodiments, the process 400 may receive a second NDD from the network device whose current location is unknown (block 440). The process 400 may receive the second NDD from the AP based on a reboot event of the AP. For example, the AP may reboot due to multiple reasons such as system updates, system crashes, system restores, or the like. Further, after reboot, the current location of the AP may be unknown to the AP. In numerous embodiments, the second NDD may include an RSSI, a BSSID, and an SSID, associated with the AP at the time of the reboot event. The second NDD may further include echo data, beacon data, RSSI data, BSSID data, and SSID data, associated with nearby network devices within the threshold proximity of the AP after the reboot event. In various embodiments, the process 400 may receive the second NDD on a per-channel basis for a plurality of RF channels in the network.

In additional embodiments, the process 400 may determine whether the second NDD matches the RF proximity map (block 445). The process 400 may determine whether the second NDD matches the RF proximity map based on a comparison of the second NDD and the RF proximity map. In further embodiments, for comparing the second NDD with the RF proximity map, the process 400 may create a new RF proximity map based on the second NDD. The process 400 may match the new RF proximity map with the RF proximity map. In still more embodiments, for comparing the second NDD with the RF proximity map, the process 400 may compare the second NDD with the first NDD to determine if the second NDD matches the first NDD. In embodiments where the process 400 sequentially receives the second NDD on a per-channel basis for the plurality of RF channels, the process 400 may perform the matching of the second NDD with the RF proximity map until a match between the second NDD and the RF proximity map is determined or the plurality of RF channels are exhausted.

In still further embodiments, if the process 400 determines that the second NDD matches the RF proximity map, the process 400 may determine that the current location of the network device (e.g., the AP) may be the same as the reference location associated with the RF proximity map (block 450). The process 400 may determine that the second NDD matches the RF proximity map based on a match of the second NDD and the first NDD. Alternatively or additionally, the process 400 may determine that the second NDD matches the RF proximity map based on a match of the new RF proximity map and the RF proximity map. In numerous additional embodiments, where the process 400 is executed at a wireless network controller (such as a WLC), the process 400 may transmit the current location of the AP to an AFC server. The process 400 may receive AFC configuration data from the AFC server based on the transmission of the current location. The process 400 may configure the AP to operate in accordance with the AFC configuration data. However, in embodiments where the process 400 is executed at the AFC server, the AFC server may generate the AFC configuration data based on the determination of the current location and configure the AP to operate in accordance with the AFC configuration data.

However, in several embodiments, if the process 400 determines that the second NDD does not match the RF proximity map, the process 400 may obtain a new reference location from the network device (block 410). In several embodiments, the new reference location can be determined by the AP in a similar manner as the reference location was determined at the first boot event, for example, by utilizing the GPS module or any other ranging technique known in the art.

Although a specific embodiment for location discovery of APs suitable for carrying out the various steps, processes, methods, and operations described herein is discussed with respect to FIG. 4, any of a variety of systems and/or processes may be utilized in accordance with embodiments of the disclosure. For example, in still additional embodiments, the first NDD and the second NDD may include echo data associated with temporary objects (for example, a passerby) within the threshold proximity of the AP. The process 400 may ignore such echo data while generating the RF proximity map. The elements depicted in FIG. 4 may also be interchangeable with other elements of FIGS. 1-3 and 5-8 as required to realize a particularly desired embodiment.

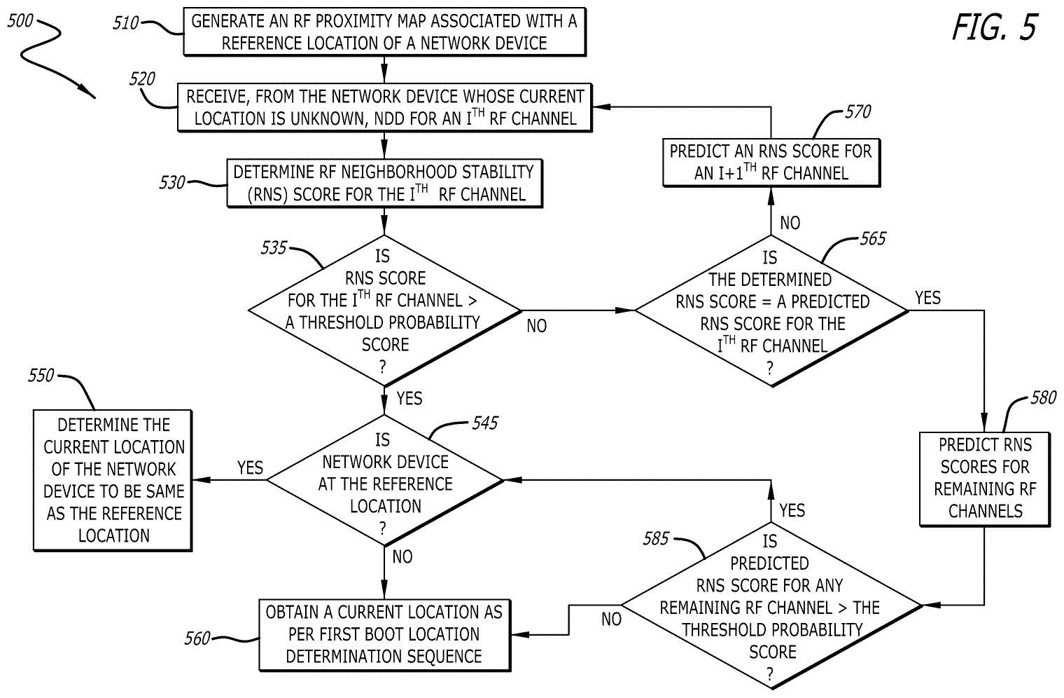

Referring to FIG. 5, a flowchart showing a process 500 for location discovery of an AP based on an RF neighborhood stability score in accordance with various embodiments of the disclosure is shown. In many embodiments, the process 500 may generate an RF proximity map associated with a reference location of a network device (block 510). For example, the process 500 may obtain the reference location from the network device (e.g., an AP) based on a first boot event of the AP. The reference location of the AP may be the last known location of the AP after the first boot event. Further, the process 500 may receive a first NDD from the AP after the first boot event. The first NDD may include an RSSI of the AP, an SSID of the AP, and a BSSID of the AP at the first boot event or after the first boot event. The first NDD may further include echo data, beacon data, SSID data, BSSID data, and RSSI data associated with network devices within a threshold proximity of the AP at the time of the first boot event. The process 500 may generate the RF proximity map based on the first NDD. The process 500 may associate the reference location with the RF proximity map.

In more embodiments, the process 500 may receive an NDD, from the network device whose current location is unknown, for an i^{th} RF channel (block 520). The i^{th} RF channel may be one of a plurality of RF channels of a network associated with the AP. The process 500 may receive the NDD (e.g., the second NDD) based on a reboot event of the AP on a per-channel basis for the plurality of RF channels. In an example, the process 500 may sequentially receive the second NDD for the plurality of RF channels. The second NDD may include an RSSI, a BSSID, and an SSID, associated with the AP at the time of the reboot event. The second NDD may further include echo data, beacon data, RSSI data, BSSID data, and SSID data, associated with the network devices that are within the threshold proximity of the AP and are communicating on the i^{th} RF channel. For example, the AP may generate the second NDD by performing passive scans, active scans on the i^{th} RF channel, where ‘i’ can range from 1 to n.

In additional embodiments, the process 500 may determine an RF neighborhood stability (RNS) score for the i^{th} RF channel (block 530). The RNS score of the i^{th} RF channel may be a metric that indicates a degree of certainty for a determination. For example, the RNS score for the i^{th} RF channel may indicate how certain the process 500 is regarding a determination of whether the AP is located in the same neighborhood as it was prior to the reboot event. The determination is made based on the second NDD for the i^{th} RF channel and the stored RF proximity map of the AP. For example, the process 500 may compare the second NDD for the i^{th} RF channel with the first NDD or the RF proximity map and determine whether the second NDD for the i^{th} RF channel matches the first NDD or the RF proximity map corresponding to the i^{th} RF channel. The process 500 may utilize one or more techniques (for example, Lyapunov exponents, Eigenvalue analysis, State-space modeling, Bayesian methods, non-Bayesian methods, Hidden Markov models, fuzzy logic, or the like) for determining whether the second NDD for the i^{th} RF channel matches the first NDD or the RF proximity map corresponding to the i^{th} RF channel. Along with an output that indicates a match probability, the process 500 may also determine the RNS score which exhibits a confidence level associated with the match probability.

In further embodiments, the process 500 may determine whether the RNS score for the i^{th} RF channel is greater than a threshold probability score (block 535). The RNS score for the i^{th} RF channel being greater than the threshold probability score may indicate that the process 500 is highly certain regarding the determination of whether the AP is located in the same neighborhood as it was prior to the reboot event. For example, the threshold probability score may be 60%. In an example scenario, the process 500 may determine that the second NDD for the i^{th} RF channel does not match the first NDD or the RF proximity map corresponding to the i^{th} RF channel and may determine the RNS score for this determination as 40%. In such a scenario, the process 500 may determine that the RNS score ‘40%’ for the determination is less than the threshold probability score 60%. In other words, the mismatch between the second NDD for the i^{th} RF channel and the first NDD or the RF proximity map corresponding to the i^{th} RF channel does not indicate with certainty that the AP is not at the same reference location. Likewise, in another scenario, the process 500 may determine that the second NDD for the i^{th} RF channel matches the first NDD or the RF proximity map corresponding to the i^{th} RF channel with the RNS score of 40%. In such a scenario, the match between the second NDD for the i^{th} RF channel and the first NDD or the RF proximity map corresponding to the i^{th} RF channel still does not indicate with certainty that the AP is at the same reference location. In other words, the determination of the RNS score for the i^{th} RF channel enables the process 500 to ensure certainty of the determination.

In still more embodiments, if the process 500 determines that the RNS score for the i^{th} RF channel is greater than the threshold probability score, the process 500 may determine whether the network device is at the reference location (block 545). In an example scenario, the process 500 may determine that the second NDD for the i^{th} RF channel matches the first NDD or the RF proximity map corresponding to the i^{th} RF channel with the RNS score of 80%. In such a scenario, since the RNS score for the i^{th} RF channel is greater than the threshold probability score, the process 500 may determine that the match between the second NDD for the i^{th} RF channel and the first NDD or the RF proximity map corresponding to the i^{th} RF channel indicates that the AP is at the same reference location. However, in another scenario, the process 500 may determine that the second NDD for the i^{th} RF channel does not match the first NDD or the RF proximity map corresponding to the i^{th} RF channel with the RNS score of 80%. In such a scenario, since the RNS score for the i^{th} RF channel is greater than the threshold probability score, the process 500 may determine that the mismatch between the second NDD for the i^{th} RF channel and the first NDD or the RF proximity map corresponding to the i^{th} RF channel indicates that the AP is not at the same reference location.

In numerous embodiments, if the network device is determined to be at a different location than the reference location, the process 500 may obtain a current location of the network device as per the first boot location determination sequence (block 560). Notably, the first boot location determination sequence may include the determination of the current location by the AP using a GPS module and transmission of the current location to the WLS or the AFC server. However, in numerous additional embodiments, if the network device is determined to be at the reference location, the process 500 may determine the current location of the network device (e.g., the AP) to be same as the reference location (block 550).

In still further embodiments, if the process 500 determines that the RNS score is less than the threshold probability score, the process 500 may determine whether the determined RNS score for the i^{th} RF channel is equal to a predicted RNS score for the i^{th} RF channel (block 565). In several embodiments, the RNS score for the i^{th} RF channel may be predicted when a second NDD corresponding to an (i−1)^{th} RF channel was received by the process 500.

In yet further embodiments, if the determined RNS score is less than the predicted RNS score, the process 500 may predict an RNS score for an (i+1)^{th} RF channel (block 570). For example, the process 500 may predict the RNS score for the (i+1)^{th} RF channel based on the second NDD associated with the i^{th} RF channel. For example, the process 500 may utilize one or more techniques (such as Lyapunov exponents, Eigenvalue analysis, State-space modeling, or the like) for predicting the RNS score for the (i+1)^{th} RF channel.

In yet additional embodiments, the process 500 may receive, from the AP, second NDD for the (i+1)^{th} RF channel (block 520). The process 500 may use the second NDD for the (i+1)^{th} RF channel in a manner that is similar to the second NDD for the i^{th} RF channel to determine the current location of the AP.

However, in many further embodiments, if the determined RNS score for the i^{th} RF channel is equal to (or greater than) the predicted RNS score for the i^{th} RF channel, the process 500 may sequentially predict RNS scores for the remaining RF channels of the plurality of RF channels (block 580). For example, the process 500 may utilize the second NDD received for all prior RF channels to determine the RNS scores for the remaining RF channels. Further, the determined RNS score for the i^{th} RF channel being equal to (or greater than) the predicted RNS score for the i^{th} RF channel may indicate that RNS score prediction is accurate and there is no longer a need to receive a second NDD for the remaining RF channels.

In still more embodiments, the process 500 may determine whether a predicted RNS score for any remaining RF channel is greater than the threshold probability score (block 585). For example, if the RNS score associated with one of the remaining RF channels is greater than the threshold probability score, the process 500 may determine whether the AP is at the reference location (block 545). However, in still additional embodiments, if the predicted RNS score for any of the remaining RF channels is not greater than the threshold probability score, the process 500 may determine the current location of the AP as per the first boot location determination sequence (block 560).

In several embodiments, the process 500 may predict the RNS score for multiple RF channels without receiving a corresponding second NDD from the AP. Such determination of the RNS scores expedites a validation mechanism of the current location of the AP. In other words, the current location of the AP may be determined in a significantly reduced time interval as the process 500 does not require waiting for the reception of NDD data from the AP. In several more embodiments, the RNS score may be affected by RF objects within the threshold proximity of the AP. One or more differences caused by RF objects that may be controlled by a WLC may be solved. However, differences from non-controlled RF objects may affect the RNS score.

Although a specific embodiment for determination of the current location of an AP based on an RNS score suitable for carrying out the various steps, processes, methods, and operations described herein is discussed with respect to FIG. 5, any of a variety of systems and/or processes may be utilized in accordance with embodiments of the disclosure. For example, in still yet additional embodiments, the process 500 may predict an RNS score associated with a future location of the AP based on historical RF data associated with the AP. Based on such prediction of the RNS score, the process 500 may further predict the current location of the AP in an instance of a reboot event. The elements depicted in FIG. 5 may also be interchangeable with other elements of FIGS. 1-4 and 6-8 as required to realize a particularly desired embodiment.

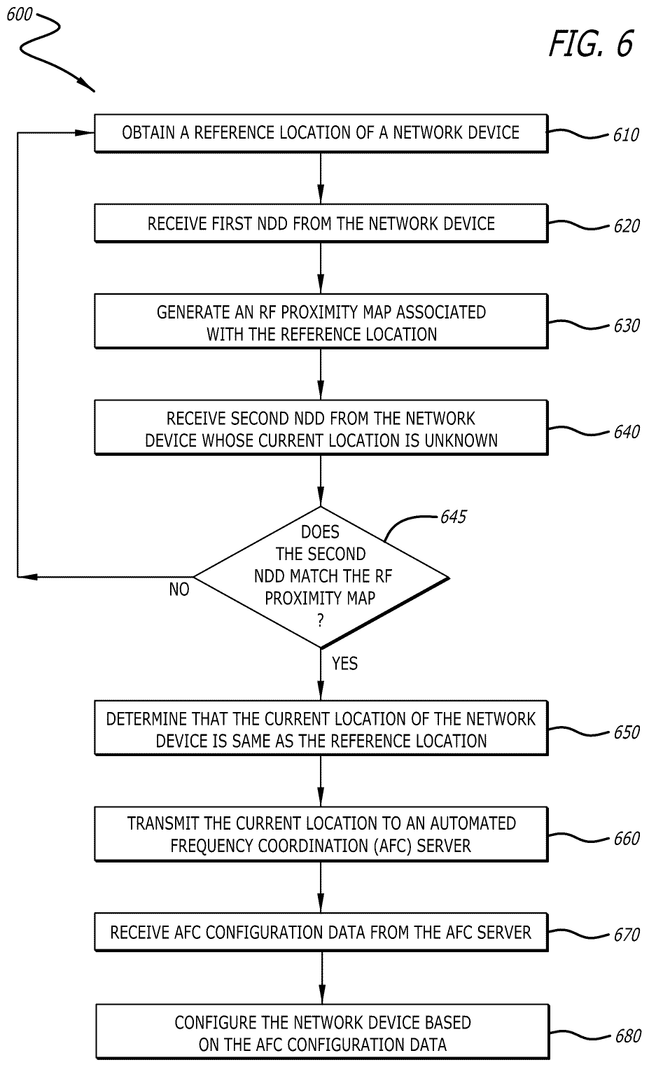

Referring to FIG. 6, a flowchart showing a process 600 for expedited location discovery of an AP at a reboot event in accordance with various embodiments of the disclosure is shown. In many embodiments, the process 600 may obtain a reference location of a network device (block 610). In an example, the network device can be an AP or any other network node for which event-triggered location determination is to be performed. The process 600 may obtain the reference location of the AP based on a first boot event of the AP. The reference location of the AP may be the last known location of the AP after the first boot event of the AP. In many examples, the reference location can be determined by the AP by utilizing a GPS module or any other ranging technique known in the art.

In a number of embodiments, the process 600 may receive a first NDD from the network device (block 620). The process 600 may receive the first NDD from the AP (e.g., the network device) based on the first boot event of the AP. The first NDD may include an RSSI of the AP, an SSID of the AP, and a BSSID of the AP. The first NDD may further include echo data, beacon data, SSID data, BSSID data, and RSSI data associated with network devices within a threshold proximity of the AP. In a variety of embodiments, the echo data may include signals received by the AP that have been reflected by the network devices within the threshold proximity of the AP. The beacon data may include information broadcasted by the network devices in the form of beacon frames. The beacon data may be used to identify the network devices, assess the capabilities of the network devices, record the reception timestamp of the beacon frames, provide channel information associated with the network devices, and evaluate the signal strength and quality associated with the network devices. The SSID data may include service set identifiers of the network devices and the BSSID data may include basic service set identifiers of the network devices. The RSSI data may include signal strengths associated with the network devices.

In further additional embodiments, the process 600 may generate an RF proximity map associated with the reference location (block 630). The process 600 may generate the RF proximity map based on the first NDD. The RF proximity map may be generated based on RF information of the network devices within the threshold proximity of the AP at the first boot event. In other words, the RF proximity map of the AP may be generated based on collected signal snapshots (e.g., the first NDD) of various nearby (e.g., within the threshold proximity) Wi-Fi devices or non-Wi-Fi devices of the AP. Further, the RF proximity map can be utilized to decipher the relative location between the AP and the nearby devices and entities. The process 600 may associate the reference location with the RF proximity map.

In more embodiments, the process 600 may receive second NDD from the network device whose current location is unknown (block 640). In several embodiments, the process 600 may receive the second NDD from the AP based on a reboot event of the AP. For example, the AP may reboot due to multiple reasons such as system updates, system crashes, system restores, or the like. Further, after reboot, a current location of the AP may be unknown to the AP. The second NDD may include an RSSI, a BSSID, and an SSID, associated with the AP at the time of the reboot event. The second NDD may further include echo data, beacon data, RSSI data, BSSID data, and SSID data, associated with nearby network devices within the threshold proximity of the AP at the reboot event. In various embodiments, the process 600 may receive the second NDD on a per-channel basis for a plurality of RF channels in the network.

In additional embodiments, the process 600 may determine whether the second NDD matches the RF proximity map (block 645). The process 600 may determine whether the second NDD matches the RF proximity map based on a comparison of the second NDD and the RF proximity map. In further embodiments, for comparing the second NDD with the RF proximity map, the process 600 may create a new RF proximity map based on the second NDD. The process 600 may match the new RF proximity map with the RF proximity map. In still more embodiments, for comparing the second NDD with the RF proximity map, the process 600 may compare the second NDD with the first NDD to determine if the second NDD matches the first NDD. In numerous embodiments, for comparing the second NDD with the RF proximity map or the first NDD, the process 600 may compare the RSSI, the BSSID, and the SSID associated with the AP in the second NDD with the RSSI, the BSSID, and the SSID associated with the AP in the first NDD. In other words, the process 600 may compare the BSSID and the SSID of the AP at the time of the first boot event with the BSSID and SSID of the AP at the time of the reboot event. Likewise, the process 600 may further compare the RSSI (e.g., signal strength) of the AP at the time of the first boot event with the RSSI of the AP at the time of the reboot event.

In numerous additional embodiments, for comparing the second NDD with the RF proximity map or the first NDD, the process 600 may compare the echo data, the beacon data, the RSSI data, the BSSID data, and the SSID data included in the first NDD with the echo data, the beacon data, the RSSI data, the BSSID data, and the SSID data included in the second NDD. In other words, the process 600 may compare the echo data, the beacon data, the RSSI data, the BSSID data, and the SSID data, associated with the network devices within the threshold proximity of the AP at the time of the first boot event with the echo data, the beacon data, the RSSI data, the BSSID data, and the SSID data, associated with the network devices within the threshold proximity of the AP at the time of reboot event.

In still further embodiments, if the second NDD matches the RF proximity map, the process 600 may determine that a current location of the network device (e.g., the AP) may be the same as the reference location associated with the RF proximity map (block 650). The process 600 may determine that the second NDD matches the RF proximity map based on a match of the second NDD and the first NDD. Alternatively or additionally, the process 600 may determine that the second NDD matches the RF proximity map based on a match of the new RF proximity map and the RF proximity map.

In still additional embodiments, the process 600 may transmit the current location of the AP to an AFC server (block 660). In several additional, the process 600 may be executed at a wireless network controller (such as a WLC). The process 600 may transmit the current location of the AP to the AFC server based on the determination of the current location of the AP.

In further additional embodiments, the process 600 may receive AFC configuration data from the AFC server (block 670). The process 600 may receive AFC configuration data based on the transmission of the current location of the AP to the AFC server. The AFC configuration data may include power levels, mode of operation, or the like that are determined based on the current location of the AP within the network. The AFC configuration data may be configured to indicate an AFC configuration using which the AP is required to operate to attain its full operational capability and meet the connectivity requirements of devices within its coverage area.

In yet further embodiments, the process 600 may configure the network device (e.g., AP) based on the AFC configuration data (block 680). The process 600 may configure the AP by transmitting the AFC configuration data to the AP. In response to receiving the AFC configuration data, the AP may initiate its operation.

However, in several embodiments, if the process 600 determines that the second NDD does not match the RF proximity map, the process 600 may obtain a new reference location from the network device (block 610). In several embodiments, the new reference location can be determined by the AP in a similar manner as the reference location was determined at the first boot event, for example, by utilizing the GPS module or any other ranging technique known in the art.

Although a specific embodiment for expedited location discovery of an AP at a reboot event suitable for carrying out the various steps, processes, methods, and operations described herein is discussed with respect to FIG. 6, any of a variety of systems and/or processes may be utilized in accordance with embodiments of the disclosure. For example, in further embodiments, the process 600 may associate the RF proximity map with a corresponding RF channel of the plurality of RF channels. Subsequently, the process 600 may acquire the second NDD associated with the RF channel that corresponds to the RF proximity map. The elements depicted in FIG. 6 may also be interchangeable with other elements of FIGS. 1-5 and 7-8 as required to realize a particularly desired embodiment.

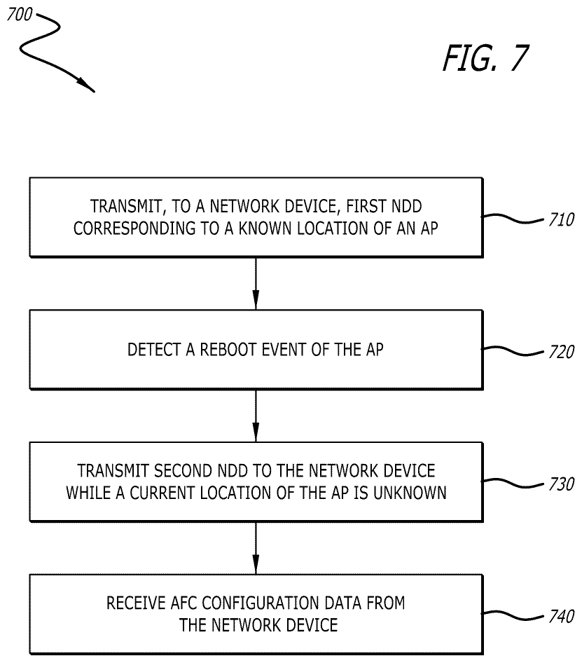

Referring to FIG. 7, a flowchart showing a process 700 for AFC registration of an AP at a reboot event in accordance with various embodiments of the disclosure is shown. In many embodiments, the process 700 may transmit a first NDD corresponding to a known location of an AP to a network device (block 710). In several embodiments, the process 700 may be executed at the AP. In many examples, the process 700 may transmit the first NDD to a WLC. In many additional examples, the process 700 may transmit the first NDD to an AFC server. The process 700 may transmit the first NDD based on a first boot event of the AP. The first NDD may include an SSID, an RSSI, and a BSSID associated with the AP at the first boot event. The first NDD may further include echo data, beacon data, SSID data, RSSI data, and BSSID data associated with network devices within a threshold proximity of the AP at the first boot event. The first NDD may correspond to a reference location that may be the known location of the AP at the first boot event. The reference location may also be the last known location of the AP. In many examples, the reference location can be determined by the AP by utilizing a GPS module, Ultra-Wide Band ranging technique, Fine Time Measurement (FTM) ranging, or any other ranging technique known in the art.

In a number of embodiments, the process 700 may detect a reboot event of the AP (block 720). The AP may reboot due to various reasons such as scheduled maintenances, system crashes, software updates, or the like. Further, after reboot, a current location of the AP may be unknown to the AP.

In a variety of embodiments, the process 700 may transmit a second NDD to the network device while the current location of the AP may be unknown (block 730). In many examples, the process 700 may transmit the second NDD to the WLC. In many additional examples, the process 700 may transmit the second NDD to the AFC server. The process 700 may transmit the second NDD based on the detection of the reboot event of the AP. The second NDD may include an RSSI, a BSSID, and an SSID, associated with the AP at the time of the reboot event. The second NDD may further include echo data, beacon data, RSSI data, BSSID data, and SSID data, associated with the network devices within a threshold proximity of the AP at the reboot event.

In further additional embodiments, the process 700 may receive AFC configuration data from the network device (block 740). In many examples, the process 700 may receive the AFC configuration data from the WLC. In many additional examples, the process 700 may receive the AFC configuration data from the AFC server. The AFC configuration data may be received based on a determination that the current location of the AP is the same as the reference location associated with the first NDD. The reference location associated with the first NDD can be the last known location of the AP prior to the reboot. The AFC configuration data may include power levels, mode of operation, or the like that are determined based on the current location of the AP within a network. The AFC configuration data may be configured to indicate an AFC configuration using which the AP is required to operate to attain its full operational capability and meet the connectivity requirements of devices within its coverage area.

Although a specific embodiment for AFC registration for receiving AFC configuration data suitable for carrying out the various steps, processes, methods, and operations described herein is discussed with respect to FIG. 7, any of a variety of systems and/or processes may be utilized in accordance with embodiments of the disclosure. For example, in more embodiments, the AP may be an RF sensing device and may be configured to determine RF measurements, noise level, interference level, signal strength, or the like associated with network devices within the threshold proximity. The elements depicted in FIG. 7 may also be interchangeable with other elements of FIGS. 1-6 and 8 as required to realize a particularly desired embodiment.

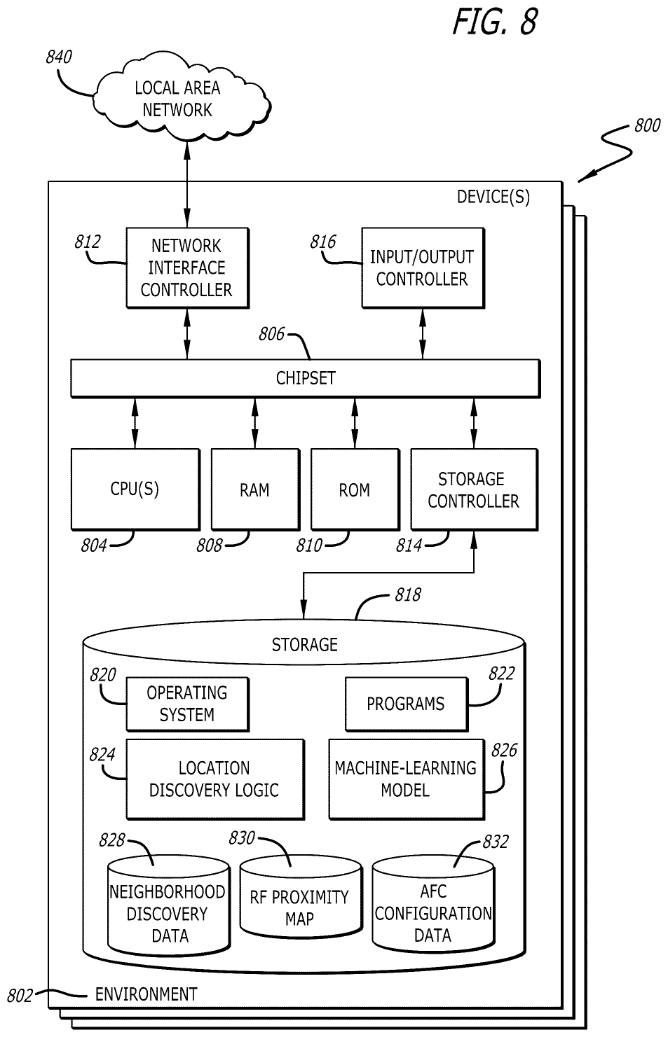

Referring to FIG. 8, a conceptual block diagram of a device 800 suitable for configuration with a location discovery logic, in accordance with various embodiments of the disclosure is shown. The embodiment of the conceptual block diagram depicted in FIG. 8 can illustrate a conventional server, computer, workstation, desktop computer, laptop, tablet, network appliance, e-reader, smartphone, or other computing devices, and can be utilized to execute any of the application and/or logic components presented herein. The embodiment of the conceptual block diagram depicted in FIG. 8 can also illustrate an access point, a switch, or a router in accordance with various embodiments of the disclosure. The device 800 may, in many nonlimiting examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, central processing units (“CPUs”) can be configured to operate in conjunction with a chipset 806. The processor(s) 804 can be standard programmable CPUs that perform arithmetic and logical operations necessary for the operation of the device 800.

In a number of embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in some embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Additional embodiments of the device 800 can be configured to operate in a networked environment using logical connections to remote computing devices and computer systems through a network, such as the network 840. The chipset 806 can include functionality for providing network connectivity through a network interface card (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for instance, store an operating system 820, applications 822, neighborhood discovery data 828, RF proximity data 830, and AFC configuration data 832 which are described in greater detail below. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 800 can store data within the storage 818 by transforming the physical state of the physical storage units to reflect the information being stored. The specific transformation of the physical state can depend on various factors. Examples of such factors can include, but are not limited to, the technology used to implement the physical storage units, whether the storage 818 is characterized as primary or secondary storage, and the like.

In many more embodiments, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement. By way of example, and not limitation, computer-readable storage media can include volatile and non-volatile, removable and non-removable media implemented in any method or technology.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In many additional embodiments, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as application 822 and transform the device 800 by specifying how the processor(s) 804 can transition between states, as described above. In some embodiments, the device 800 has access to computer-readable storage media storing computer-executable instructions which, when executed by the device 800, perform the various processes described above with regard to FIGS. 1-7. In certain embodiments, the device 800 can also include computer-readable storage media having instructions stored thereupon for performing any of the other computer-implemented operations described herein.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other types of output device. Those skilled in the art will recognize that the device 800 might not include all of the components shown in FIG. 8 and can include other components that are not explicitly shown in FIG. 8 or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 800 to perform the functions described herein. The virtualization layer may generally support a virtual resource that performs at least a portion of the techniques described herein.

In many further embodiments, the device 800 may include a location discovery logic 824. The location discovery logic 824 may be configured to perform one or more of the various steps, processes, operations, and/or other methods that are described above. Often, the location discovery logic 824 can be a set of instructions stored within a non-volatile memory that, when executed by the processor(s)/controller(s) 804 can carry out these steps, etc. In certain embodiments, the location discovery logic 824 may perform various operations related to the location discovery of an AP that has undergone a reboot event. The location discovery logic 824 may be configured to generate an RF proximity map based on a first NDD associated with the AP. The location discovery logic 824 may be further configured to receive a second NDD associated with the AP based on the reboot event of the AP. The location discovery logic 824 may be further configured to compare the second NDD with the RF proximity map. The location discovery logic 824 may be further configured to determine, based on a match of the second NDD with the RF proximity map, a reference location associated with the RF proximity map to be an AP/current location of the AP.

In a number of embodiments, the storage 818 can include neighborhood discovery data (NDD) 828. In additional embodiments, the NDD 828 can include information associated with the AP and one or more network devices positioned within a threshold proximity of the AP. The NDD 828 may include an SSID, an RSSI, and a BSSID associated with the AP at the first boot event. The NDD 828 may further include echo data, beacon data, SSID data, RSSI data, and BSSID data associated with the network devices positioned within the threshold proximity of the AP.

In various embodiments, the storage 818 can include RF proximity map 830. In several embodiments, the RF proximity map 830 can comprise RF information regarding the AP and the network devices within the threshold proximity of the AP. The RF proximity map 830 may be updated periodically or based on a change in the location of the AP. The RF proximity map 830 may be associated with a reference location. The reference location may be the last known location of the AP. The reference location may be updated based on a change of location of the AP. In some embodiments, the RF proximity map 830 can indicate the relative location between the AP and the nearby devices and entities. The process 400 may associate the reference location with the RF proximity map 830.

In a number of embodiments, the storage 818 can include AFC configuration data 832. The AFC configuration data 832 may be generated by an AFC server coupled with the device 800 based on the location of the AP. The AFC configuration data 832 may be specific to the AP. The AFC configuration data 332 may include power levels, mode of operation, or the like according to which the AP 304 is required to operate to fulfill its operational requirements.

Finally, in numerous additional embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more linear regression models, logistic regression models, decision trees, Naïve Bayes models, neural networks, k-means cluster models, random forest models, and/or other types of ML models 826. The ML model(s) 826 can be configured to generate inferences to make predictions or draw conclusions from data. An inference can be considered the output of a process of applying a model to new data. This can occur by learning from at least the NDD 828, the RF proximity map 830, and the AFC configuration data 832, and utilizing the learning to predict future outcomes. For example, the ML model(s) 826 can be trained to predict the AFC configuration data 832 based on the location of the AP. In many additional examples, the ML model(s) 826 can be trained to predict the RNS scores for RF channels based on the NDD 828. The ML model(s) 826 may be configured to learn AFC configurations based on patterns of AFC configuration data that correspond to NDD data matching with a specific RF proximity map. Based on the learned patterns, the ML model(s) 826 may be configured to derive a set of rules associated with the AFC configurations. Based on the set of rules, the ML model(s) 826 may be configured to predict the AFC configuration data 832 for the AP. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes.

Although a specific embodiment for a device suitable for configuration with a dynamic proxying logic for carrying out the various steps, processes, methods, and operations described herein is discussed with respect to FIG. 8, any of a variety of systems and/or processes may be utilized in accordance with embodiments of the disclosure. For example, the device may be in a virtual environment such as a cloud-based network administration suite, or it may be distributed across a variety of network devices or switches. The elements depicted in FIG. 8 may also be interchangeable with other elements of FIGS. 1-7 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a network interface controller configured to provide access to a network; and
a memory communicatively coupled to the processor, wherein the memory comprises a location discovery logic that is configured to:
generate a radio frequency (RF) proximity map associated with a reference location;
receive neighborhood discovery data from a network device; and
determine that a current location of the network device is same as the reference location based on the RF proximity map and the neighborhood discovery data.

2. The device of claim 1, wherein the location discovery logic receives the neighborhood discovery data based on a reboot of the network device.

3. The device of claim 2, wherein the reference location associated with the RF proximity map is a last known location of the network device prior to the reboot.

4. The device of claim 1, wherein the neighborhood discovery data comprises at least one of: a received signal strength indicator (RSSI), a service set identifier (SSID), or a basic service set identifier (BSSID), associated with the network device.

5. The device of claim 4, wherein the neighborhood discovery data further comprises at least one of: echo data, beacon data, SSID data, BSSID data, or RSSI data, associated with one or more other network devices.

6. The device of claim 5, wherein the one or more other network devices are positioned within a threshold proximity of the network device.

7. The device of claim 1, wherein the network includes a plurality of RF channels.

8. The device of claim 7, wherein the location discovery logic is further configured to receive the neighborhood discovery data for one or more RF channels of the plurality of RF channels.

9. The device of claim 1, wherein the location discovery logic generates the RF proximity map at a first boot event of the network device.

10. The device of claim 9, wherein the location discovery logic is further configured to periodically update the RF proximity map.

11. The device of claim 9, wherein prior to generating the RF proximity map, the location discovery logic is further configured to receive at least one of: an RSSI, an SSID, or a BSSID, associated with the network device at the first boot event.

12. The device of claim 11, wherein prior to generating the RF proximity map, the location discovery logic is further configured to receive at least one of: echo data, beacon data, SSID data, BSSID data, or RSSI data, associated with one or more other network devices within a threshold proximity of the network device at the first boot event.

13. The device of claim 12, wherein the location discovery logic generates the RF proximity map based on at least one of: the RSSI, the SSID, or the BSSID, associated with the network device at the first boot event and at least one of: the echo data, the beacon data, the SSID data, the BSSID data, or the RSSI data, associated with the one or more other network devices at the first boot event.

14. The device of claim 13, wherein at least one other network device of the one or more other network devices is coupled with the device.

15. The device of claim 14, wherein the location discovery logic is further configured to determine the current location of the network device based on a physical address of the at least one other network device.

16. The device of claim 1, wherein the location discovery logic is further configured to transmit the current location of the network device to an Automated Frequency Coordination (AFC) server.

17. The device of claim 16, wherein the location discovery logic is further configured to:
receive AFC configuration data from the AFC server based on the transmission of the current location of the network device; and
configure the network device based on the AFC configuration data.

18. The device of claim 1, wherein for determining the current location of the network device, the location discovery logic is further configured to:
compare the RF proximity map with the neighborhood discovery data; and
determine an RF neighborhood stability (RNS) score based on the comparison, wherein the determination that the current location of the network device is same as the reference location is based on the RNS score being greater than a threshold probability score.

19. A device, comprising:
a processor;
a network interface controller configured to provide access to a network; and
a memory communicatively coupled to the processor, wherein the memory comprises a location discovery logic that is configured to:
transmit, to a network device, first neighborhood discovery data corresponding to a known location of the device;
detect a reboot event of the device;
transmit, in response to detecting the reboot event, second neighborhood discovery data to the network device while a current location of the device is unknown; and
receive Automated Frequency Coordination (AFC) configuration data from the network device based on a match of the second neighborhood discovery data with the first neighborhood discovery data.

20. A method, comprising:
generating a radio frequency (RF) proximity map associated with a reference location;
receiving neighborhood discovery data from a network device; and
determining that a current location of the network device is same as the reference location based on the RF proximity map and the neighborhood discovery data.
